(19) United States
(12) Patent Application Publication
(10) Pub. No.: US 2024/0394907 A1
(43) Pub. Date: Nov. 28, 2024

(54) DEVICES, SYSTEMS, AND METHODS TO REMOTELY MONITOR SUBJECT POSITIONING

(71) Applicant: Hill-Rom Services, Inc., Batesville, IN (US)

(72) Inventors: Christopher Nelson, Batesville, IN (US); Harsh Dweep, Batesville, IN (US)

(73) Assignee: Hill-Rom Services, Inc., Batesville, IN (US)

(21) Appl. No.: 18/672,672

(22) Filed: May 23, 2024

Related U.S. Application Data
(60) Provisional application No. 63/504,323, filed on May 25, 2023.

(51) Int. Cl. G06T 7/70; G06T 7/00; G08B 21/04

(52) U.S. Cl. CPC G06T 7/70; G06T 7/0012; G08B 21/0476; G06T 2207/10016; G06T 2207/10048; G06T 2207/20081; G06T 2207/20084; G06T 2207/30196; G06T 2207/30232

(57) ABSTRACT

A method includes receiving subject training data comprising a plurality of images of subjects in a plurality of positions on a person support apparatus, labeling the plurality of images based on the positions of the subjects to generate labeled subject training data, generating synthetic training data comprising computer generated images of artificial subjects in a plurality of positions on an artificial person support apparatus, labeling the synthetic training data based on the positions of the artificial subjects to generate labeled synthetic training data, and training a machine learning model based on the labeled subject training data and the labeled synthetic training data, using supervised learning techniques, to generate a trained model to predict a subject position based on an image of the subject.

### CROSS-REFERENCE TO RELATED APPLICATION

This application claims priority to U.S. Provisional Application No. 63/504,323 filed on May 25, 2023, the entire contents of which is hereby incorporated by reference herein.

### FIELD

The present disclosure generally relates to subject monitoring, and more particularly, to a method to remotely monitor subject positioning in a person support apparatus.

### BACKGROUND

Certain immobile or partially immobile subjects may get pressure injuries or suffer other conditions if allowed to remain in an immobile state on a person support apparatus for an extended period of time. In addition, certain subject positions may indicate conditions, emergencies, or other situations that need to be addressed by a clinician. Accordingly, it may be desirable to remotely monitor subject positioning on the support apparatus.

### SUMMARY

In one aspect, a method may include receiving subject training data comprising a plurality of images of subjects in a plurality of positions on a person support apparatus, labeling the plurality of images based on the positions of the subjects to generate labeled subject training data, generating synthetic training data comprising computer generated images of artificial subjects in a plurality of positions on an artificial person support apparatus, labeling the synthetic training data based on the positions of the artificial subjects to generate labeled synthetic training data, and training a machine learning model based on the labeled subject training data and the labeled synthetic training data, using supervised learning techniques, to generate a trained model to predict a subject position based on an image of the subject.

In another aspect, a computing device may include a processor configured to receive subject training data comprising a plurality of images of subjects in a plurality of positions on a person support apparatus, label the plurality of images based on the positions of the subjects to generate labeled first subject data, generate synthetic training data comprising computer generated images of artificial subjects in a plurality of positions on an artificial person support apparatus, label the synthetic training data based on the positions of the artificial subjects to generate labeled synthetic training data, and train a machine learning model based on the labeled subject training data and the labeled synthetic training data, using supervised learning techniques, to generate a trained model to predict a subject position based on an image of the subject

In another aspect, a system may include one or more cameras configured to capture a plurality of images of subjects in a plurality of positions on a person support apparatus, and a computing device communicatively coupled to the one or more cameras. The computing device may include a processor configured to receive subject training data comprising a plurality of images of subjects in a plurality of positions on the person support apparatus, label the plurality of images based on the positions of the subjects to generate labeled first subject data, generate synthetic training data comprising computer generated images of artificial subjects in a plurality of positions on an artificial person support apparatus, label the synthetic training data based on the positions of the artificial subjects to generate labeled synthetic training data, and train a machine learning model based on the labeled subject training data and the labeled synthetic training data, using supervised learning techniques, to generate a trained model to predict a subject position based on an image of the subject.

These and other features, and characteristics of the present technology, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a perspective view of an illustrative person support apparatus including a vision system, according to one or more embodiments shown and described herein;

FIG. 2 schematically depicts the vision system of FIG. 1, according to one or more embodiments shown and described herein;

FIG. 3 schematically depicts example memory modules of the vision system of FIGS. 1 and 2, according to one or more embodiments shown and described herein;

FIG. 4 depicts a flow diagram of an example method to train a machine learning model, according to one or more embodiments shown and described herein; and

FIG. 5 depicts a flow diagram of an example method to remotely monitor subject positioning in a support apparatus, according to one or more embodiments shown and described herein.

### DETAILED DESCRIPTION

The present disclosure relates to devices, systems, and methods to remotely monitor subject positioning in a support apparatus. In particular, a machine learning model is trained to predict a position of a subject in a support apparatus based on one or more images of the subject in the support apparatus. In particular, the machine learning model may receive training data comprising subject volunteers positioned in a variety of different positions and may train the machine learning model using supervised learning techniques. The machine learning model may also receive synthetic data comprising computer generated images of subjects in positions that may be difficult for subject volunteers to recreate. The machine learning model may also receive other types of data such as infrared images, depth values, load sensor values, and the like.

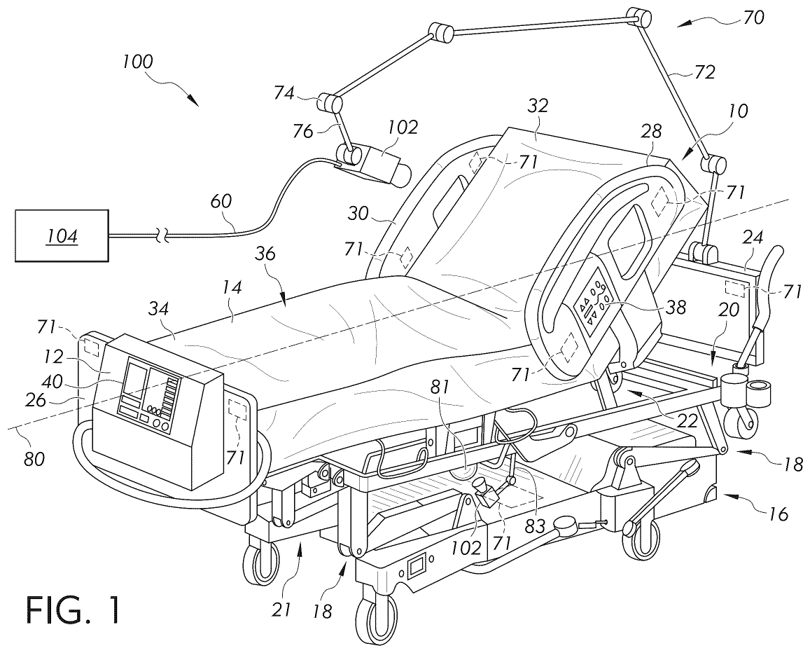

Turning now to the figures, FIG. 1 illustrates a vision system 100 utilizable with a person support apparatus 10, according to one or more embodiments of the present disclosure. The person support apparatus 10 includes a person support surface 14. In the illustrated embodiment, the person support apparatus 10 is a bed and the person support surface 14 is a mattress. However, in other examples, the person support apparatus 10 may comprise a gurney, an operating table, a chair, a wheelchair, and the like. In the illustrated example, the person support apparatus 10 includes a base frame 16, an intermediate frame 20 coupled to the base frame 16 by linkages 18, and an articulating deck frame 22 that is coupled to the intermediate frame 20 and that supports the person support surface 14. The person support apparatus 10 also includes a head end 24, a foot end 26, a left side rail 28, and a right side rail 30. In the illustrated example, the left side rail 28 is positioned at a left edge of the person support apparatus 10, such that the left side rail 28 and the right side rail 30 is positioned at a right edge of the person support apparatus 10, such that the left side rail 28 and the right side rail 30 are operable to help maintain the subject on the person support apparatus 10 and help prevent the subject from falling off the person support apparatus 10, for example, by or rolling or turning over the left edge or right edge, respectively. A longitudinal axis 80 extends from the head end 24 to the foot end 26. The articulating deck frame 22 includes separate sections that articulate relative to the base frame 16 and relative to each other, for example, a mattress center section 36 that is height adjustable, and a mattress head section 32 and a mattress foot section 34 that are adjustable in elevation relative to the mattress center section 36. A control panel 38 is used to actuate and control articulation of the articulating deck frame 22. While the illustrated embodiment illustrates the left side rail 28 and the right side rail 30 extending along the mattress head section 32, either or both of the left side rail 28 and the right side rail 30 may also extend along either or both of the mattress center section 36 and the mattress foot section 34 in addition to or in lieu of extending along the mattress head section 32. In embodiments, rails (not illustrated) are provided at the head end 24 and/or the foot end 26 as illustrated with respect to the left side rail 28 and the right side rail 30.

In the illustrated embodiment, a control system 12 is provided on the person support apparatus 10. The control system 12 includes a user interface 40 for controlling various components and/or features of the person support surface 14, such as different onboard sensor systems and or therapy systems that may be incorporated into the person support apparatus 10.

In the illustrated embodiment, a vision system 100 is integrated with the person support apparatus 10 for determining a body position of a subject on the person support surface 14. The vision system 100 includes at least one camera 102 and a computer 104 communicatively coupled to the at least one camera 102. In the illustrate example, the computer 104 is provided as a separate component from the person support apparatus 10. Accordingly, the computer 104 may be located in a different room than the person support apparatus 10, for example, in room dedicated for computer and server equipment. Alternatively, the computer 104 may be provided on a mobile cart that may be moved into proximity of the person support apparatus 10 on an as needed or as desired basis. In other embodiments, the computer 104 may be fixed to the person support apparatus 10, for example, the computer 104 may be integrated within the control system 12 of the person support apparatus 10. Also, in the illustrated embodiment, the at least one camera 102 communicates with the computer 104 via a cable 60. In other embodiments, the at least one camera 102 and the computer 104 may communicate wirelessly. While FIG. 1 illustrates the at least one camera 102 as a single camera, the at least one camera 102 may include a plurality of cameras, as described below, and each of the cameras are communicatively coupled to the computer 104 via wired and/or wireless communication.

The at least one camera 102 may be supported by the person support apparatus 10 and/or by some external means. In the illustrated embodiment, the at least one camera 102 is supported by a boom 70 that is coupled to person support apparatus 10. Here, the boom 70 is supported on the head end 24 of the person support apparatus 10, with a first end of the boom 70 being coupled to the head end 24 and a second end of the boom 70 being coupled to the at least one camera 102. In other embodiments, the at least one camera 102 may be provided on a mobile cart that may be moved into proximity of the person support apparatus 10 on an as needed or as desired basis and, in some embodiments, the at least one camera 102 and the computer 104 are provided on the same mobile cart. The at least one camera 102 may be coupled to the mobile cart via the boom 70 in a similar manner as described with reference to the person support apparatus 10.

In other embodiments, the boom 70 may be coupled to the foot end 26, the left side rail 28, and/or the right side rail 30. In embodiments where the at least one camera 102 includes two or more cameras, each camera may be supported by the same boom or separate booms, and such same or separate booms may be coupled to the foot end 26, the left side rail 28, the right side rail 30, and/or from another structure (e.g., ceiling, wall, furniture, etc.). Thus, the person support apparatus 10 may include a plurality of mounting sites 71 for mounting the boom 70 and/or the at least one camera 102, and the at least one camera 102 and/or the boom 70 may be mounted at any one or more of the mounting sites 71 about the person support apparatus 10. While FIG. 1 depicts the mounting sites 71 at particular locations on the person support apparatus 10, it should be understood that these locations are merely illustrative and the present disclosure is not limited to such locations. Regardless of where the at least one camera 102 and the boom 70 are mounted, the at least one camera 102 is oriented such that the subject is within a field of view of the at least one camera 102, including when the subject may reposition themselves on the person support surface 14, incline or decline the person support surface 14, etc. In embodiments, the boom 70 and the at least one camera 102 are coupled to the mattress head section 32 such that the boom 70 and the at least one camera 102 move with the mattress head section 32 as it is inclined or declined. In other embodiments, the computer 104 may be in communication with the control panel 38 (or a controller of the control panel 38) utilized to control articulation of the articulating deck frame 22 (e.g., by sending a control signal to the articulating deck frame 22 instructing the articulating deck frame 22 to incline or decline), such that the computer 104 automatically moves the boom 70 to adjust the position and/or orientation of the at least one camera 102 based on movement of the articulating deck frame 22 to ensure that the subject remains in the field of view of the camera at least one 102 as the mattress head section 32 inclines and/or declines.

In the illustrated embodiment, the boom 70 includes a plurality of linkage arms 72 interconnected and coupled to each other via a plurality of rotational joints 74, and the at least one camera 102 is supported on a distal most linkage arm 76 of the plurality of linkage arms 72. In embodiments, the distal most linkage arm 76 is a gimbal (e.g., a three axis gimbal) from which the at least one camera 102 is suspended. The rotational joints 74 may each include an individual motor that is in communication with the computer 104, such that the computer 104 is operable to control movement of the rotational joints 74 that are motorized. In this manner, each of the rotational joints 74 is separately controllable so as to articulate the linkage arms 72 in a plurality of degrees of freedom and thereby to position the at least one camera 102 in a desired orientation relative to the subject. Accordingly, the boom 70 may operate as a robotic arm. However, less than all of the rotational joints 74 may be motorized. For example, in some embodiments, the rotational joints 74 are not motorized, such that the boom 70 operates as an extendible arm that may move relative to the person support apparatus 10. In embodiments, the boom 70 may be folded up and stowed so that it is not obstructing the space surrounding the person support apparatus 10, for example, it may be folded and stowed underneath the person support apparatus 10, and this feature may be incorporated regardless of whether or not the rotational joints 74 are motorized. In embodiments, the computer 104 is operable to control actuation of at least some of the rotational joints 74 to thereby adjust the field of view of the at least one camera 102 based on an orientation of a person support surface 14 (e.g., whether inclined or declined) of the person support apparatus 10 as sensed by the at least one camera 102. Thus, the computer 104 may utilize feedback or data that is received from the at least one camera 102 and indicative of an orientation of the articulating deck frame 22 to thereby move or adjust position of the field of view of the at least one camera 102. In embodiments, the computer 104 may utilize feedback or data from the articulating deck frame 22 or the control panel 38 associated therewith to move or adjust position of the field of view of the at least one camera 102. For example, in embodiments, the computer 104 may be in communication with motors of each of the rotational joints 74 as well as the control panel 38 utilized to control articulation of the articulating deck frame 22, such that the computer 104 causes actuation of the rotational joints 74 to adjust the position and/or orientation of the boom 70 and the at least one camera 102 based on movement of the articulating deck frame 22, to thereby ensure that the subject remains in the field of view of the at least one camera 102 as the mattress head section 32 inclines and/or declines. In embodiments, any one or more of the at least one camera 102 may also be oriented such that its/their field of view captures or is focused on things, such as views of the subject's medications (e.g. amount of medication remaining in an IV bag) and/or views of health monitors within the room (e.g. SpO2, respiration rate, ECG, NIBP, temperature, EtCO2, blood pressure, etc.). Also, by utilizing one or more additional cameras focused on the subject, a three dimensional (3-D) view of the subject may be developed, which 3-D view may provide additional information as to the subject's orientation/positioning on the person support surface 14, as well as the subject's tidal volume (i.e., with each breath), total mass/change in mass, etc.

The at least one camera 102 may be supported at various other locations about the person support apparatus 10, in addition to or instead of the at least one camera 102 being mounted to the person support surface 14 via the boom 70, as described above. For example, the at least one camera 102 may be coupled to the base frame 16, the intermediate frame 20, and/or the articulating deck frame 22. In embodiments, the at least one camera 102 is coupled to person support apparatus 10 at a location between base frame 16 and the articulating deck frame 22. In embodiments, the at least one camera 102 is coupled to a lower surface 21 of the person support surface 14 that is opposite the mattress. In embodiments, the at least one camera 102 is mounted within the left side rail 28 and/or the right side rail 30.

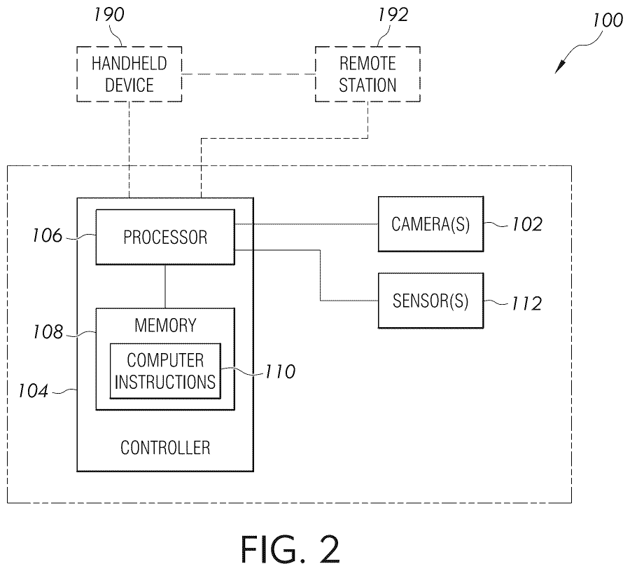

In embodiments, a mirror 81 (e.g., a mirrored dome) is mounted to the lower surface 21 of the person support surface 14 or a lower surface of the articulating deck frame 22. The mirror 81 may be mounted thereto in any suitable manner such as by fasteners, adhesives, or the like. The mirror 81 includes a reflective outer surface which allows the mirror 81 to reflect light in a complete 360 degree field of view around the person support apparatus 10. As further described, utilization of the mirror 81 enables the at least one camera 102 to obtain an enlarged and redirected field of view around the person support apparatus 10. In these embodiment, the at least one camera 102 may be mounted such that the mirror 81 is within the field of view of the at least one camera 102, for example, the at least one camera 102 may be mounted on an upper surface of the base frame 16 such that the at least one camera 102 is directed towards and faces the mirror 81. In the illustrated embodiment, the at least one camera 102 is located directly below the mirror 81, between the mirror 81 and the base frame 16, and oriented such that the field of view of the at least one camera 102 is directed in an upward vertical direction towards the mirror 81. In these embodiments, the at least one camera 102 may be supported by a mounting arm 83. The mounting arm 83 may be provided similar to as described with regard to the boom 70 such that the mounting arm 83 allows for adjustment of the at least one camera 102, or the mounting arm 83 may be a fixed and rigidly support the at least one camera 102 in a fixed orientation. Additionally, it should be appreciated that the mounting arm 83 may be thin in cross section and/or constructed of transparent material to prevent substantial obstruction of light directed on to or reflected off the mirror 81. Here, the at least one camera 102 has a field of view that is wide enough to capture image data of the entire outer surface of the mirror 81, for example, the field of view of at least one camera 102 may extend across an entire diameter of the mirror 81 (e.g., configured as a mirrored dome) so that the entire outer surface thereof may be viewed by the at least one camera 102. Accordingly, the at least one camera 102 is able to capture images of any object in the area surrounding the person support apparatus 10 below a plane defined by the lower surface 21 based on light that is incident on the outer surface of the mirror 81. It should be appreciated that light from certain objects may be obstructed from being incident on and reflected by the outer surface of the mirror 81 by the mounting arm 83 or other components of the person support apparatus 10 extending between the articulating deck frame 22 and the base frame 16. Accordingly, the at least one camera 102 collects image data of an area surrounding the person support apparatus 10 below the plane corresponding with the lower surface 21. As described in more detail herein, the image data is transmitted to the computer 104 (FIG. 2), which processes the image data.

The at least one camera 102 is configured to capture images in any electromagnetic frequency range, including the infra-red spectrum and the visible spectrum. That is, the at least one camera 102 may include various types of cameras and/or optical sensors. For example, the at least one camera 102 may include various types of optical sensors, including RGB, IR, FLIR, LIDAR optical sensors, or a combination thereof. Where the at least one camera 102 includes a plurality of cameras. The cameras may be of the same type, or may be of two or more different types. In embodiments, the at least one camera 102 may be configured to capture still images and/or video. Because the at least one camera 102 is modular, it may be swapped with other types of cameras as may be desired based on the clinical needs of the subject. For example, an RGB camera may remove from the boom 70 (or one of the booms 70) and replaced with a IR camera. The at least one camera 102 may capture still images, a plurality of images over a predetermined time period, and/or video.

In embodiments, the at least one camera 102 is removable from the distal most linkage arm 76 and/or the rotational joint 74 provided thereon. In embodiments, the boom 70 is removable from the person support apparatus 10 and may, for example, be attached to other equipment and/or furniture proximate to the person support apparatus 10. While the boom 70 is illustrated attached to the foot end 26 of the person support apparatus 10, it may be attached to different portions or structures of the person support apparatus 10. Also, even though the boom 70 may be robotically controlled, it may be manually moved, for example, by a nurse or caretaker, so as to reposition the at least one camera 102 as may be desired. As mentioned, the at least one camera 102 of the vision system 100 may include a plurality of cameras and, where utilized, any one or more of the cameras may be supported by the boom 70. In embodiments, at least some of those additional cameras may be mounted such that their fields of view capture the environment around the person support apparatus 10, such as items in a hospital room (or corridor) and/or other subjects that may be located in the path that the person support apparatus 10 is moving (i.e., during transport), which may be useful for detecting object detections and/or identifying positioning of people/objects with relation to the subject.

Regardless of whether the at least one camera 102 is supported by a structure, such as the boom 70, or is directly mounted to a portion of the person support apparatus 10, the at least one camera 102 may be mounted in a modular fashion so that it can be easily replaced and/or swapped. Also, where the at least one camera 102 has been removed from the boom 70 and/or some other mounting structure, a cover may be provided or placed over an empty slot of the boom 70 or other mounting structure so that the empty slot appears more aesthetically pleasing. Additionally, if a cover is utilized, a more continuous surface is easier to clean/sterilize than an empty slot.

Because some subjects may exhibit anxiety when being imaged by the at least one camera 102, especially when in close proximate to the at least one camera 102, the at least one camera 102 and/or its optics may be camouflaged. For example, the at least one camera 102 may be integrated within a portion of the person support apparatus 10, and some components of the at least one camera 102 may be hidden, embedded, or otherwise obscured with opaque covers (e.g., glass with dark colors) or the like such that the cameras are indistinguishable from the mounting surface. In embodiments, the at least one camera 102 is integrated and embedded in the left side rail 28, the right side rail 30, the head end 24, and/or the foot end 26 of the person support apparatus 10.

FIG. 2 illustrates a block diagram of the vision system 100, according to one or more embodiments of the present disclosure. As mentioned above, the vision system 100 generally includes the computer 104. The computer 104 may be communicatively coupled to at least one monitor. In some embodiments, the at least one monitor may include, for example and without limitation, at least one handheld device 190 and/or at least one remote station 192. The computer 104 includes at least one processor 106 and at least one non-transitory memory module 108 (hereinafter, the memory 108) that are communicatively coupled to one another. The memory 108 includes computer readable and executable instructions 110 that may be executed by the processor 106. Accordingly, it should be understood that the at least one processor 106 may be any device capable of executing the computer readable and executable instructions 110. For example, the processor 106 may be a controller, an integrated circuit, a microcontroller, a computer, or any other computing device.

As mentioned, the vision system 100 includes the at least one camera 102. As shown, the at least one camera 102 is communicatively coupled to the processor 106 for monitoring the subject and determining a body position of the subject on the person support apparatus 10, as herein described. The vision system 100 may further at least one sensor 112 communicatively coupled to the processor 106 for monitoring other parameters of the subject. Values measured by the at least one sensor 112 may be utilized by the computer 104 in determine the body position of the subject on the person support apparatus 10, as disclosed herein. The processor 106 of the computer 104 is also communicatively coupled to the at least one sensor 112.

The vision system 100 also includes a power source. In embodiments, the person support apparatus 10 includes a power source and the vision system 100 draws power (is powered by) the power source of the person support apparatus 10. In other embodiments, the vision system 100 includes a power source that is external or separate from the person support apparatus 10.

The at least one handheld device 190 and the at least one remote station 192 are remote devices that may each be communicatively coupled to the computer 104 and may each be communicatively coupled to each other. The at least one remote station 192 may include a processor and a non-transitory memory module that are communicatively coupled to one another, wherein the non-transitory memory module of the at least one remote station 192 includes computer readable and executable instructions that may be executed by the processor of the at least one remote station 192. The at least one remote station 192 may include one or more displays for outputting data for viewing by the subject and/or caregivers, as hereinafter described. Similarly, the at least one handheld device 190 may include a processor and a non-transitory memory module that are communicatively coupled to one another, wherein the non-transitory memory module of the at least one handheld device 190 includes computer readable and executable instructions that may be executed by the processor of the at least one handheld device 190. Also, the at least one handheld device 190 may include one or more displays for outputting data for viewing by the subject and/or caregivers, as hereinafter described. In embodiments, the at least one handheld device 190 includes a plurality of handheld devices and/or the at least one remote station 192 includes a plurality of remote stations. In embodiments, the initialization of the vision system 100 may be achieved via the at least one handheld device 190 and/or the at least one remote station 192. In embodiments, the at least one handheld device 190 and the at least one remote station 192 may stream data from the at least one camera 102 and/or the at least one sensor 112. In embodiments, the at least one handheld device 190 and/or the at least one remote station 192 are operable to control operation of the vision system 100 and/or operable to control operation or positioning of at least one camera 102. In embodiments, the at least one handheld device 190 and/or the at least one remote station 192 may display a body position of the subject on the person support apparatus 10 determined by the computer 104, as disclosed herein.

In embodiments, the sensors are worn by the subject. In embodiments, the sensors are positioned on the person support apparatus 10. For example, the sensors may be positioned on the left side rail 28 and/or the right side rail 30, and/or may be positioned at the head end 24 (e.g., at a headboard) and/or at the foot end 26 (e.g., at a footboard) of the person support apparatus 10. The sensors may include temperature sensors, infrared sensors, depth sensors, pressure sensors, capacitive sensors, inductive sensors, optical sensors, load beams, load cells, load sensors, moisture sensors, etc. The sensors may be configured to measure or sense physiological conditions or biomarkers of the subject, for example, such as oxygen saturation (SpO2), skin degradation, heart rate or pulse rate, blood pressure, etc. The sensors may also measure other parameters associated with the subject, such as a depth from the sensors to the subject or a weight or load of the subject on the person support apparatus 10.

The computer readable and executable instructions 110 of the vision system 100 may include various types of algorithms or programs for performing various functions or features. For example, one or more algorithms may be stored in the memory 108 of the computer 104. The algorithms may pertain to video analytics for subject positioning, subject identification, identification of objects/items in the environment surrounding the subject, etc. In embodiments, the memory 108 storing the algorithms may be modular/removable to allow removal and replacement. In embodiments, the algorithms are stored on an external storage device (e.g., solid state external drive) that is communicatively coupled to the computer 104, for example, via an input port or USB port of the computer 104. In embodiments, the memory 108 is incorporated within the computer 104.

In embodiments, the vision system 100 is couplable to one or more cameras or camera systems external the vision system. For example, the computer 104 may be communicatively coupled to one or more other cameras in addition to the at least one camera 102. Such additional cameras may be wall or ceiling mounted, or mounted elsewhere in the room in proximity to the subject, and/or may be modular. For example, the computer 104 may be communicatively coupled to a camera located in a room within which the subject is located, such that the vision system 100 is able to keep track and monitor the subject even when they are not on the person support apparatus 10. In addition to observing the subject when they are not on the person support apparatus 10, such one or more other cameras may help facilitate calibration of the at least one camera 102, for example, due to changes in light. That is, the memory 108 may include an algorithm that calibrates the at least one camera 102 based on ambient light detected by the at least one camera 102, the at least one sensor 112, and/or the one or more other cameras. For example, the at least one sensor 112 may include one or more ambient light sensors, which may be coupled the person support apparatus 10 and/or elsewhere about the room within which the person support apparatus 10 is provided. Depending on the amount of ambient light in the room, as sensed by the one or more ambient light sensors, the computer 104 may adjust calibration of the at least one camera 102 to optimize the at least one camera 102 for use in that ambient light in which the at least one camera 102 is operating. Stated differently, the computer 104 may calibrate the at least one camera 102 based on ambient light data received from the at least one ambient light sensors. In another embodiment, a light emitter is provided that emits light at a known wave length that the ambient light sensor captures and the computer 104 calibrates the at least one camera 102 based on the light received from the light emitter.

In embodiments, the vision system 100 may include one or more security features. For example, the computer 104 may include mechanical locks and/or other devices to physically protect the components of the computer 104 from unauthorized third parties. Also, data stored on the vision system 100, for example, on the memory 108, may include password protection and/or encryption to safe guard data thereon from unauthorized access.

In embodiments, the vision system 100 may be configured to establish a network connection so as to communicate with one or more remote servers. For example, the computer 104 may communicate wireless or via a wired connection with one or more remote servers. In this manner, data from the at least one camera 102 and/or the at least one sensor 112 may be remotely streamed on a device/display associated with the remote server. Also, depending on the nature of the algorithm stored in the memory 108, the algorithm may generate output and such output may be monitored remotely on device/display associated with the remote server, as well as on the at least one handheld device 190 and the at least one remote station 192.

In embodiments, the vision system 100 is operable to automatically adjust or position the at least one camera 102 based on position of the subject. For example, the algorithm stored in the memory 108 may, when executed by the processor 106, control positioning of the field of view of the at least one camera 102 (and/or the angle at which the at least one camera 102 is oriented) based on feedback regarding the orientation or articulation of the articulating deck frame 22. With reference to FIGS. 1 and 2, the vision system 100 may be communicatively coupled to the control panel 38, such that the processor 106 receives the feedback regarding orientation or articulation of the articulating deck frame 22, the mattress head section 32, the mattress center section 36, and/or the mattress foot section 34 from the control panel 38 (or from a controller of the articulating deck frame 22) and utilizes such feedback to automatically adjust or position the at least one camera 102. In embodiments, the feedback is indicative of a position (e.g., a vertical spacing) of the articulating deck frame 22 relative to the base frame 16, an angle at which the mattress head section 32 is positioned relative to the mattress center section 36, and/or an angle at which the mattress foot section 34 is positioned relative to the mattress center section 36. For example, the control panel 38 is operable to adjust the articulating deck frame 22, the mattress head section 32, the mattress center section 36, and/or the mattress foot section 34, and the processor 106 is in communicate with the control panel 38 such that the computer 104 is operable to move the at least one camera 102 and adjust its field of view based on the position of the articulating deck frame 22, the mattress head section 32, the mattress center section 36, and/or the mattress foot section 34. In embodiments, the computer 104 is operable to calibrate the at least one camera 102 based on feedback from the control panel 38. For example, articulation of the person support apparatus 10 may result in a subject (and/or another object) being at least partially outside of the field of view of the at least one camera 102, and/or such movement of the person support apparatus 10 may result in the at least one camera 102 being out of focus, and the computer 104 may automatically move and/or focus the at least one camera 102 to ensure that the subject (and/or other objects) are within the field of view and/or within focus of the at least one camera 102. Thus, when the articulating deck frame 22 of the person support apparatus 10 inclines or declines, the processor 106 receives data indicative of the orientation of the articulating deck frame 22 from the control panel 38 and correspondingly adjusts position or orientation of the at least one camera 102 based on the same. In some of these embodiments or other in other embodiments, the at least one sensor 112 senses position of the subject and the processor 106 receives data therefrom indicative of the position of the subject and correspondingly adjusts position or orientation of the at least one camera 102 based on the position of the subject. In this manner, the at least one camera 102 may remain focused on the subject (or other object) regardless of movement (e.g., incline or decline) of the articulating deck frame 22.

In embodiments, the vision system 100 automatically repositions the at least one camera 102 based on optical feedback. For example, the algorithm stored in the memory 108 may cause the processor 106 to automatically adjust the field of view of the at least one camera 102 in cases where the subject (or other object) is nearing an edge or periphery of the field of view, to ensure that the subject (or other object) remains substantially centered or sufficiently within the field of view. In these embodiments, the algorithm is written such that the at least one camera 102 or other one or more of the at least one sensor 112 senses a position of the subject (or another object) and, as the subject (or other object) nears an edge or periphery of the field of view, as determined by data received from the at least one camera 102 and/or the at least one sensor 112, the processor 106 causes the at least one camera 102 to reposition based on feedback from the at least one camera 102 or the at least one sensor 112.

In embodiments, the vision system 100 may be associated with a particular person support apparatus 10. For example, a particular person support apparatus 10 may have a unique identifier and the unique identifier may be programmed into the computer 104 such that a user utilizing the vision system 100 will understand that the vision system is associated with the person support apparatus 10 having the particular unique identifier. In this manner, staff using the vision system 100 may know exactly which one of the person support apparatus 10 is being monitored, decreasing any chance of confusion as to which bed and/or subject is being monitored, as the vision system 100 is just associated with a single bed. Therefore, the vision system 100 is associated with the subject who is on the particular on of the person support apparatus 10. This may enable caregivers to track how long the subject is on the person support apparatus 10 and identify instances where the subject leaves or exits the person support apparatus 10. In other embodiments, the vision system 100 may be associated with more than one bed and/or more than one subject.

In embodiments, the memory 108 includes a facial recognition algorithm. In these embodiments, the facial recognition algorithm may associate a subject to the specific one of the person support apparatus 10 on which the at least one camera 102 is located. This may allow clinicians to identify which subjects are in which hospital rooms, and it may also provide a means to associate data from the bed to a subject. For example, where the person support apparatus 10 is capturing biometric data about the subject, such as heart rate, respiratory rate, weight, height, time that the subject spends on the person support apparatus 10, instances of when the subject exists/leaves the person support apparatus 10, etc., such data may be associated with the subject that was identified via the facial recognition algorithm located on the memory 108. Further, the vision system 100 may be communicatively coupled to an electronic medical record (“EMR”) database, and such biometric data may be sent to the EMR associated with the subject and/or the subject's EMR may be updated based on the biometric data.

In embodiments, the vision system 100 may also utilize indicators such as a bar code (or QR code) or a numerical designation that, when placed in the subject's room and within view of the at least one camera 102, causes the vision system 100 to recognize the person support apparatus 10 (on which the subject is placed) is located within a specific room. In embodiments, the bar code, QR code, numerical designation, or other type of indicator may be provided as a label. When utilized in combination with the facial recognition algorithm, the at least one camera 102 may capture an image of both the subject (i.e., the subject's face) and the bar code, and the processor 106 may identify the subject and the data on the bar code and then associate the subject with the data on the bar code. For example, the data on the bar code may be indicative of a particular room and/or a particular one of the person support apparatus 10, and then the processor 106 may then associate the recognized subject with the particular room and/or the particular one of the person support apparatus 10 indicated on the bar code. Where utilized, a bar code may be provided on a sticker, and the sticker with the bar code may be placed on the person support apparatus 10 or on a wall (or piece of furniture) that is in the field of view of the at least one camera 102. Further, a central computer system of the hospital may be communicatively coupled with the vision system 100 and track location of the vision system 100 and/or the person support apparatus 10 associated therewith wherever it is located (e.g., within the hospital), such that the central computer system may thereby track location of the subject that is associated with the vision system 100 and/or the person support apparatus 10. This may enable caregivers to track the subject throughout the hospital, for example, in scenarios where the subject leaves or exits the bed. For example, the vision system 100 may enable tracking how long the subject is (or has been) positioned on the person support apparatus 10. In some examples, the person support apparatus 10 is in a single room, and the vision system 100 may enable tracking how the subject has been in that particular room. For example, the room may be associated with a certain service or certain type of care, such that the vision system 100 is operable to track how long the subject has been undergoing that type of service of care.

In some clinical situations, immobile or partially immobile subjects may get pressure injuries or suffer other conditions if allowed to remain in an immobile state on the person support apparatus 10 for an extended period of time. In addition, certain subject positions may indicate conditions, emergencies, or other situations that need to be addressed by a clinician. Accordingly, as disclosed herein, the vision system 100 may determine the body position of the subject on the person support apparatus 10 based on data captured by the camera 102 and/or the sensors 112. If the vision system 100 determines that the subject has remained in the same position for longer than a threshold amount of time, or is in a dangerous position, an alert can be generated, as disclosed herein. As used herein, a dangerous position is a body position of a subject that may lead to injury regardless of how long the subject remains in the position.

The computer 104 may maintain a machine learning model that may be trained to predict the body position of the subject on the person support apparatus 10, as disclosed herein. After the machine learning model is trained, in operation, the camera 102 and/or the sensors 112 may capture data (e.g., images) of the subject on the person support apparatus 10. The collected data may be input to the trained machine learning model, which may output a predicted body position of the subject.

During training of the machine learning model, subject volunteers may position themselves on the person support apparatus 10 in a variety of positions. For example, subject volunteers may follow a script instructing them to assume different positions in a particular sequence. As the subject volunteers are positioned in different positions, the camera 102 captures images of the subject volunteers. The sensors 112 may also capture data associated with the subject volunteers. The captured data may be labeled based on the particular position (e.g., lying on stomach, lying on back, lying on right side, sitting up, and the like) that a subject volunteer is assuming when an image or other sensor data is captured to generate training data. The computer 104 may then train the machine learning model to predict subject body position based on the training data, as disclosed in further detail below. Different subject volunteers may have different ages, weights, and body shapes, and may position themselves slightly differently for each instructed subject position. In addition, training data may be captured in a variety of lighting conditions, from a variety of angles with respect to the person support apparatus 10, and with different amounts and types of sheets or other bedding on the person support apparatus 10 and/or covering the subject (e.g., the subject may be lying under a sheet or lying under a blanket).

In some examples, the boom 70 may move the camera 102 to different positions during training to capture images of the subject volunteers from different perspectives. In some examples, the vision system 100 may include lights that can be adjusted in shade and/or intensity in order to capture training data in different lighting conditions. As such, a variety of training data may be captured to train the machine learning model without overfitting the model to a narrow set of training data (e.g., to a particular body type or camera perspective).

As images and other sensor data is captured by the camera 102 and/or the sensors 112, the captured images and sensor data may be transmitted to the computer 104. The computer 104 may receive images from the camera 102 and data from the sensors 112 and may train and maintain a machine learning model to predict subject positioning based on the received images and sensor data, as disclosed herein. During training, the computer 104 may receive training data, and may train the machine learning model based on the received training data using supervised learning techniques. After the machine learning model is trained, during real-time operation, the computer 104 may receive real-time data from the camera 102 and/or the sensors 112 and input the received data into the trained model. The computer 104 may predict a position of the subject based on the received data.

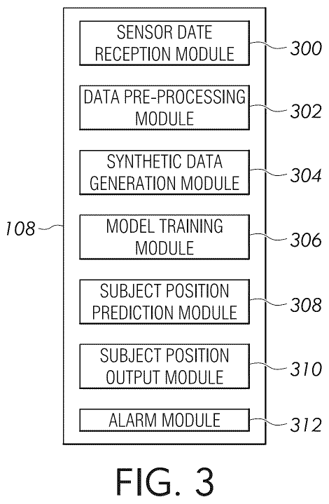

As used herein, real-time operation refers to operation of the vision system 100 to determine a position of a subject on the person support apparatus 10 after the machine learning model has been trained. As used herein, real-time data refers to data received from the camera 102 and/or the sensors 112 during real-time operation. Operation of the computer 104 is discussed in further detail below with respect to FIG. 3.

FIG. 3 depicts a plurality of modules that may be included in the memory 108. Referring to FIG. 3, the memory 108 includes a sensor data reception module 300, a data pre-processing module 302, a synthetic data generation module 304, a model training module 306, a subject position prediction module 308, a subject position output module 310, and an alarm module 312. Each of the sensor data reception module 300, the data pre-processing module 302, the synthetic data generation module 304, the model training module 306, the subject position prediction module 308, the subject position output module 310, and the alarm module 312 may be a program module in the form of operating systems, application program modules, and other program modules stored in the memory 108. Such a program module may include, but is not limited to, routines, subroutines, programs, objects, components, data structures and the like for performing specific tasks or executing specific data types as will be described below.

The sensor data reception module 300 includes programming for causing the processor 106 to receive sensor data from the camera 102 and/or the one or more sensors 112. As discussed above, the camera 102 may capture images of subjects or subject volunteers on the person support apparatus 10. The sensors 112 may also capture other data associated with subjects or subject volunteers on the person support apparatus 10. During training, the camera 102 and/or the sensor 112 capture training data of subject volunteers. During real-time operation, the camera 102 and/or the sensors 112 capture real-time data of a subject on the person support apparatus 10. In either case, the camera 102 and/or the sensors 112 transmit captured data to the computer 104, and the data may be received by the sensor data reception module 300. As discussed above, the data received by the sensor data reception module 300 may include a variety of data such as video or still images of a subject on the person support apparatus 10, infrared images of the subject (which may provide heat data), data from a depth sensor, data from a load sensor, and/or the like.

The data pre-processing module 302 includes programming for causing the processor 106 to pre-process the data received by the sensor data reception module 300 before the data is input to the machine learning model. In one example, the sensor data reception module 300 may receive video from the camera 102, and the data pre-processing module 302 may split the video into a plurality of frames. In some examples, the sensor data reception module 300 may receive a variety of different types of data (e.g., RGB images, infrared images, depth values, load values), and the data pre-processing module 302 may combine the different types of data into a single training example to be input into the machine learning model. For example, one training example may comprise an image of a subject volunteer on the person support apparatus 10 and load sensor data from when the image was captured. The data pre-processing module 302 may combine these two pieces of data into a single training example to be input to the machine learning model. In other examples, the data pre-processing module 302 may perform other types of data pre-processing such as formatting data, filtering data, cropping images, and the like.

The synthetic data generation module 304 includes programming for causing the processor 106 to generate synthetic training data, as disclosed herein. As used herein, synthetic data means computer generated data, such as images, video and the like. As discussed above, the sensor data reception module 300 receives training data captured of subject volunteers in a variety of different positions on the person support apparatus 10. The sensor data reception module 300 may also receive training data captured of subject volunteers performing different types of actions, such as waving their hands or arms, and the like.

However, there may be particular positions or actions that may be difficult for subject volunteers to perform. For example, it may be desirable to train the machine learning model to determine that a subject is choking. However, it may not be possible to capture an image of a subject volunteer choking during a training session. While a subject volunteer may perform actions that simulate choking, such actions may be less realistic than a person actually choking. Accordingly, it may be desirable to generate synthetic data of a person choking or performing other actions or subject positions, in order to increase the amount of training data available to the machine learning model.

In the illustrated example, the synthetic data generation module 304 may generate synthetic or artificial images of a subject performing certain actions or in certain positions (e.g., choking). In the illustrated example, the synthetic data generation module 304 may generate synthetic or artificial data associated with positions or actions that may be difficult for a subject volunteer to replicate, such as choking. However, in other examples, the synthetic data generation module 304 may generate synthetic data associated with any subject position or action for which additional data is desired. For example, the synthetic data generation module 304 may generate synthetic data of subjects having body types for which actual subject volunteers are unavailable. This may increase the amount of training data available to the machine learning model, thereby improving its effectiveness after training.

In the illustrated example, the synthetic data generation module 304 may generate computer generated images (CGI) of different subject positions or actions. This may be achieved using a variety of different computer graphic or other techniques. Each synthetic data image may be labeled based on the position or action of a simulated subject in a particular CGI. In some examples, the synthetic data generation module 304 may generate other types of synthetic data (e.g., infrared images or depth values).

The model training module 306 includes programming for causing the processor 106 to train the machine learning model, as disclosed herein. As discussed above, the computer 104 may maintain a machine learning model that receives, as input, image data and/or sensor data associated with a subject on the person support apparatus 10, and output a classification indicating a body position or action of the subject. In the illustrated example, the machine learning model maintained by the computer 104 is a convolutional neural network (CNN). However, in other examples, the machine learning model maintained by the computer 104 may be any other type of model that can receive sensor data input and output a predicted position or action of a subject (e.g., other types of neural networks, support vector machine, or the like).

In the illustrated example, the model training module 306 utilizes the You Only Look Once (YOLO) algorithm to train the machine learning model. However, in other examples, the model training module 306 may utilize other techniques to train the machine learning model. In the illustrated example, the model training module 306 utilizes supervised learning to train the machine learning model, using training data received by the sensor data reception module 300.

The training data comprise sensor data captured by the camera 102 and/or the sensors 112 as well as ground truth values indicating a body position or action performed by a subject volunteer when a particular image or other sensor data was captured. For example, if a subject volunteer is following a script while training data is being corrected, each position or action in the script may include a label for the training data captured when the subject volunteer is performing a particular action or position. In examples in which synthetic training data is generated by the synthetic data generation module 304 is used, the model training module 306 may use synthetic training data to train the machine learning model. In some examples, after the model is trained, additional training data may be used by the model training module 306 to update the training of the model.

In some examples, the model training module 306 may combine synthetic training data generated by the synthetic data generation module 304 and training data captured from subject volunteers. In some examples, the model training module 306 may combine different types of training data (e.g., RGB images, infrared images, load values, and depth values).

The model training module 306 may train the machine learning model using supervised learning techniques. For example, the model may comprise an input layer, an output layer, and a number of hidden layers, with each layer having any number of nodes. A parameter may be associated with each such node. A loss function may be defined based on a difference between predicted classifications of body positions based on the training data, and the actual ground truth values of the labeled body positions associated with the training data. The model training module 306 trains the machine learning model by learning parameters that minimize this loss function using one or more optimization algorithms (e.g., gradient descent). The learned parameters of the model may be stored in the memory 108.

The subject position prediction module 308 includes programming for causing the processor 106 to predict the position of a subject on the person support apparatus 10 during real-time operation, as disclosed herein. In particular, after the machine learning model is trained by the model training module 306, as discussed above, the trained model may be used to make real-time predictions of subject positioning.

In operation, after the machine learning model has been trained, the camera 102 and/or the sensors 112 capture images or other sensor data of a subject on the person support apparatus 10. In the illustrated example, the camera 102 and/or the sensors 112 may continually capture images and/or other sensor data of the subject on the person support apparatus 10. The camera 102 and/or the sensors 112 then transmit the captured sensor data to the computer 104, as discussed above. The sensor data reception module 300 may receive the images and/or other sensor data. In some examples, the data pre-processing module 302 may perform data pre-processing (e.g., splitting video data into a plurality of frames). The subject position prediction module 308 may then input the pre-processed sensor data into the trained machine learning model. In some examples, the subject position prediction module 308 may identify the subject in an image and place a bounding box or other identifier around the subject.

The subject position prediction module 308 may then determine a predicted body position and/or action of the subject based on the output of the machine learning model. As discussed above, the machine learning model classifies the sensor data into a subject position or action based on the input sensor data. As such, the output of the machine learning model may indicate a body position and/or action of the subject on the person support apparatus 10 in real-time.

The subject position output module 310 may output the subject position determined by the subject position prediction module 308 to the handheld device 190 and/or the remote station 192. In some examples, the subject position output module 310 may cause the determined subject position to be displayed on a monitor or display connected to the computer 104. In other examples, the subject position output module 310 may transmit the determined subject position to the handheld device 190, the remote station 192, or other remote computing device, which may cause the determined subject position to be displayed thereon.

Displaying the determined subject position may allow a clinician to glance at the monitor or display and quickly determine the subject position. In some examples, the subject position output module 310 may display an image or a simulated image of the subject position. For example, the computer 104 may store a preset images corresponding to different subject positions (e.g., subject lying face down, subject lying on right side, subject sitting up, and the like), and cause the present image corresponding to the determined body position to be displayed. In other examples, the subject position output module 310 may output text indicating the position of the subject. In some examples, the subject position output module 310 may display information indicating how long a subject has been in the same position (e.g., by displaying a histogram).

The alarm module 312 includes programming for causing the processor 106 to output an alarm if the subject position determined by the subject position prediction module 308 is potentially dangerous. In embodiments, when the subject position prediction module 308 determines that the subject has assumed a new body position, the alarm module 312 may start a timer to keep track of how long the subject has remained in the same position. Every time the subject changes body position, the timer may be reset.

The computer 104 may store one or more thresholds indicating how long a subject can safely remain in particular body positions. In one example, the computer 104 may store a single threshold indicating how long a subject can safely remain in any one position. In other examples, the computer 104 may store different thresholds associated with different body positions (e.g., some body positions may be more likely than others to result in pressure injuries). In embodiments, the alarm module 312 may output an alarm if a subject on the person support apparatus 10 has been in the same position for longer than a threshold amount of time associated with that position. This may allow a clinician to assist the subject in changing positions if the subject has been in the same position for too long to avoid a pressure injury. In another example, the alarm module 312 may output an alarm if the subject is in a dangerous position (e.g., choking) for any amount of time. This may allow for a clinician to immediately assist the subject.

The alarm module 312 may cause the processor 106 to output an alarm in a variety of manners. For example the alarm module 312 may output a visual and/or audio alarm to alert a clinician (e.g., a visual or audio alarm may be displayed or output by the handheld device 190 and/or the remote station 192). In some examples, the alarm module 312 may cause an alarm to be output by the computer 104 (e.g., a screen may visually display an alarm notification and/or speakers may output an audio alarm).

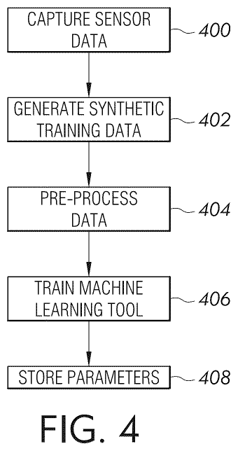

FIG. 4 depicts a flowchart of an example method for training the machine learning model maintained by the computer 104, as disclosed herein. At block 400, the sensor data reception module 300 receives training data captured by the camera 102 and/or the sensors 112. The training may include video, still images, and other data (e.g., infrared images and depth values) of subject volunteers in a variety of positions on the person support apparatus 10. As described above, in some examples, the subject volunteers may follow a script where they pose in different positions in a particular sequence to generate the training data. The training data received by the sensor data reception module 300 may be labeled with the position of the subject volunteer when the training data was captured by the camera 102 and/or the sensors 112.

At block 402, the synthetic data generation module 304 generates synthetic training data. As described above, the synthetic data generation module 304 may generate images of artificial subjects positioned in various poses. The synthetic training data generated by the synthetic data generation module 304 may be combined with the training data received by the sensor data reception module 300 to generate a combined set of training data.

At block 404, the data pre-processing module 302 may pre-process data the training data received by the sensor data reception module 300 and/or the synthetic training data generated by the synthetic data generation module 304. In one example, the data pre-processing module 302 may split video into a plurality of frames. In other examples, the data pre-processing module 302 may perform other types of data pre-processing.

At block 406, the model training module 306 trains the machine learning model using the training data received by the sensor data reception module 300 and the synthetic training data generated by the synthetic data generation module 304. In particular, the model training module 306 may train the machine learning model to predict a position of a subject on the person support apparatus 10 based on data collected by the camera 102 and/or the sensors 112. The model training module 306 may learn parameters of the machine learning model that minimize a loss function based on a difference between the ground truth values associated with the training data and the output classification of the machine learning model.

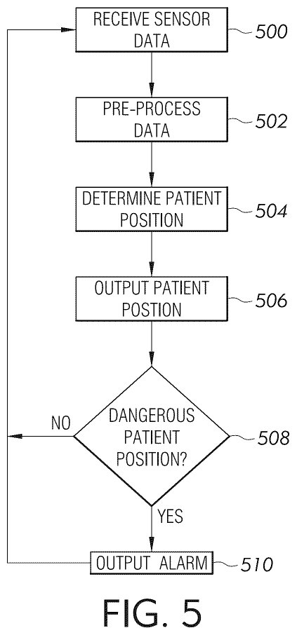

At block 408, the model training module 306 stores the learned parameters of the machine learning model in the memory 108. After the machine learning model is trained, the trained model may be used to predict subject positioning, as discussed below with respect to FIG. 5.

FIG. 5 depicts a flowchart of an example method for utilizing the trained machine learning model to determine a position of a subject on the person support apparatus 10. At block 500, the sensor data reception module 300 receives real-time sensor data from the camera 102 and/or the sensors 112. The sensor data may be captured by the sensors while a subject is on the person support apparatus 10. In some examples, a clinician or operator of the vision system 100 may cause the vision system 100 to begin operating and collecting data when a subject is on the person support apparatus 10 by pressing a button or utilizing a start function on the computer 104. In other examples, the vision system 100 may automatically detect the present of a subject on the person support apparatus 10 and begin collecting data after the subject is detected.

At block 502, the data pre-processing module 302 pre-processes the data received by the sensor data reception module 300. For example, the data pre-processing module 302 may extract images from video. In other examples, the data pre-processing module 302 may perform other types of data pre-processing. The pre-processing of the data may transform the received data into the appropriate format to be input to the machine learning model. In some examples, the sensor data received by the sensor data reception module 300 may not be pre-processed, and block 502 may be omitted.

At block 504, the subject position prediction module 308 inputs the sensor data received by the sensor data reception module 300 into the trained machine learning model. In particular, the received data is supplied to the input layer of the trained model (e.g., each pixel of an image may be input to one node of the input layer of the trained model). The machine learning model may then classify the sensor data into a particular subject position, based on the learned parameters of the model, and output the classification as a predicted subject position. As such, the subject position prediction module 308 may determine a real-time position of the subject based on real-time sensor data.

At block 506, the subject position output module 310 outputs the subject position determined by the subject position prediction module 308. For example, the subject position output module 310 may cause an image or a description of the determined subject position to be displayed by the handheld device 190 or the remote station 192.

At block 508, the alarm module 312 determines whether the subject has been in the same position for longer than a threshold amount of time or whether the subject is in a dangerous position (e.g., choking). If the alarm module 312 determines that the subject is in a dangerous position or has been in the same position for longer than a threshold amount of time (YES at block 508), then at block 510, the alarm module 312 outputs an alarm. If the alarm module 312 determines that the subject is not in a dangerous position and has not been in the same position for longer than a threshold amount of time (NO at block 508), then control returns to block 500.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It should now be understood that embodiments described herein are directed to methods to remotely monitor subject positioning in a support apparatus. As discussed above, subject volunteers can pose in a variety of different positions in a support apparatus and sensor data can be captured of these subject volunteers to create training data. By using subject volunteers, a robust set of training data can be created. In particular, different subject volunteers will have different body types and will typically have slightly different body positions for each pose. For example, certain subject volunteers lying on their right side in the support apparatus may pose slightly differently than other subject volunteers.

In addition to collecting training data from subject volunteers, synthetic images may be generated to produce additional training data. This synthetic training data may allow for the use of subject positions or actions that may be difficult for subject volunteers to reproduce. Synthetic training data may be combined with training data from subject volunteers to enlarge the available training data.

Once training data is collected, a machine learning model may be trained on the training data using supervised learning techniques. As such, the machine learning model may be trained to receive input sensor data (e.g., images of a subject in a support apparatus) and output a predicted body position of the subject in the support apparatus. By training a machine learning model to determine subject positions, a hospital may utilize the trained machine learning model to automatically monitor subject positioning without the direct involvement of clinicians. As subject positioning is automatically monitored, a system may determine if a subject is in a dangerous positions (e.g., choking) or has been a particular position too long, which may lead to pressure injuries. When this occurs, a clinician may be notified by an alarm, such that the clinician can attend to the subject.

Further aspects of the invention are provided by the subject matter of the following clauses.

A method comprising receiving subject training data comprising a plurality of images of subjects in a plurality of positions on a person support apparatus; labeling the plurality of images based on the positions of the subjects to generate labeled subject training data; generating synthetic training data comprising computer generated images of artificial subjects in a plurality of positions on an artificial person support apparatus; labeling the synthetic training data based on the positions of the artificial subjects to generate labeled synthetic training data; and training a machine learning model based on the labeled subject training data and the labeled synthetic training data, using supervised learning techniques, to generate a trained model to predict a subject position based on an image of the subject.

The method of any previous clause, wherein the machine learning model comprises one or more convolutional neural networks.

The method of any previous clause, wherein the subject training data further comprises depth values associated with the subjects in the plurality of positions on the person support apparatus.

The method of any previous clause, wherein the subject training data further comprises load sensor data associated with the subjects in the plurality of positions on the person support apparatus.

The method of any previous clause, wherein the subject training data further comprises infrared images of the subjects in the plurality of positions on the person support apparatus.

The method of any previous clause, wherein the subject training data includes video of the subjects, the method further comprising splitting the video of the subjects into the plurality of images of the subjects.

The method of any previous clause, further comprising: receiving a real-time image of a first subject on a first person support apparatus; inputting the real-time image into the trained model; and predicting a first position of the first subject based on an output of the trained model.

The method of any previous clause, further comprising displaying information about the first position of the first subject.

The method of any previous clause, further comprising causing a handheld device to display information about the first position of the first subject.

The method of any previous clause, further comprising causing a remote computing device to display information about the first position of the first subject.

The method of any previous clause, further comprising displaying a predetermined image associated with the first position of the first subject.

The method of any previous clause, further comprising causing a handheld device to display a predetermined image associated with the first position of the first subject.

The method of any previous clause, further comprising causing a remote computing device to display a predetermined image associated with the first position of the first subject.

The method of any previous clause, further comprising: determining an amount of time that the first subject has been in the first position; and upon determination that the first subject has been in the first position for greater than a predetermined threshold amount of time, outputting a warning.

The method of any previous clause, further comprising: determining whether the first subject is in a dangerous position; and upon determination that the first subject is in the dangerous position, outputting a warning.

A computing device comprising a processor configured to: receive subject training data comprising a plurality of images of subjects in a plurality of positions on a person support apparatus; label the plurality of images based on the positions of the subjects to generate labeled first subject data; generate synthetic training data comprising computer generated images of artificial subjects in a plurality of positions on an artificial person support apparatus; label the synthetic training data based on the positions of the artificial subjects to generate labeled synthetic training data; and train a machine learning model based on the labeled subject training data and the labeled synthetic training data, using supervised learning techniques, to generate a trained model to predict a subject position based on an image of the subject.

The computing device of any previous clause, wherein the machine learning model comprises one or more convolutional neural networks.

The computing device of any previous clause, wherein the subject training data further comprises depth values associated with the subjects in the plurality of positions on the person support apparatus.

The computing device of any previous clause, wherein the subject training data further comprises load sensor data associated with the subjects in the plurality of positions on the person support apparatus.

The computing device of any previous clause, wherein the subject training data further comprises infrared images of the subjects in the plurality of positions on the person support apparatus.

The computing device of any previous clause, wherein the processor is further configured to: receive video of the subjects; and split the video of the subjects into the plurality of images of the subjects.

The computing device of any previous clause, wherein the processor is further configured to: receive a real-time image of a first subject on a first person support apparatus; input the real-time image into the trained model; and predict a first position of the first subject based on an output of the trained model.

The computing device of any previous clause, wherein the processor is further configured to display information about the first position of the first subject.

The computing device of any previous clause, wherein the processor is further configured to cause a handheld device to display information about the first position of the first subject.

The computing device of any previous clause, wherein the processor is further configured to cause a remote computing device to display information about the first position of the first subject.

The computing device of any previous clause, wherein the processor is further configured to display a predetermined image associated with the first position of the first subject.

The computing device of any previous clause, wherein the processor is further configured to cause a handheld device to display a predetermined image associated with the first position of the first subject.

The computing device of any previous clause, wherein the processor is further configured to cause a remote computing device to display a predetermined image associated with the first position of the first subject.

The computing device of any previous clause, wherein the processor is further configured to: determine an amount of time that the first subject has been in the first position; and upon determination that the first subject has been in the first position for greater than a predetermined threshold amount of time, output a warning.

The computing device of any previous clause, wherein the computing device is further configured to: determine whether the first subject is in a dangerous position; and upon determination that the first subject is in the dangerous position, output a warning.

A system comprising: one or more cameras configured to capture a plurality of images of subjects in a plurality of positions on a person support apparatus; and a computing device communicatively coupled to the one or more cameras, the computing device comprising a processor configured to: receive subject training data comprising a plurality of images of subjects in a plurality of positions on the person support apparatus; label the plurality of images based on the positions of the subjects to generate labeled first subject data; generate synthetic training data comprising computer generated images of artificial subjects in a plurality of positions on an artificial person support apparatus; label the synthetic training data based on the positions of the artificial subjects to generate labeled synthetic training data; and train a machine learning model based on the labeled subject training data and the labeled synthetic training data, using supervised learning techniques, to generate a trained model to predict a subject position based on an image of the subject.

The system of any previous clause, wherein the machine learning model comprises one or more convolutional neural networks.

The system of any previous clause, further comprising one or more sensors configured to capture additional subject training data comprising depth values associated with the subjects in the plurality of positions on the person support apparatus.

The system of any previous clause, further comprising one or more sensors configured to capture additional subject training data comprising load sensor data associated with the subjects in the plurality of positions on the person support apparatus.

The system of any previous clause, further comprising one or more sensors configured to capture additional subject training data comprising capture infrared images of the subjects in the plurality of positions on the person support apparatus.

The system of any previous clause, wherein: the one or more cameras are further configured to capture video of the subjects; and the processor is further configured to split the video of the subjects into the plurality of images of the subjects.

The system of any previous clause, wherein the processor is further configured to: receive a real-time image of a first subject on a first person support apparatus; input the real-time image into the trained model; and predict a first position of the first subject based on an output of the trained model.

The system of any previous clause, wherein the processor is further configured to display information about the first position of the first subject.

The system of any previous clause, wherein the processor is further configured to cause a handheld device to display information about the first position of the first subject.

The system of any previous clause, wherein the processor is further configured to cause a remote computing device to display information about the first position of the first subject.

The system of any previous clause, wherein the processor is further configured to display a predetermined image associated with the first position of the first subject.

The system of any previous clause, wherein the processor is further configured to cause a handheld device to display a predetermined image associated with the first position of the first subject.

The system of any previous clause, wherein the processor is further configure to cause a remote computing device to display a predetermined image associated with the first position of the first subject.

The system of any previous clause, wherein the processor is further configured to: determine an amount of time that the first subject has been in the first position; and upon determination that the first subject has been in the first position for greater than a predetermined threshold amount of time, output a warning.

The system of any previous clause, wherein the computing device is further configured to: determine whether the first subject is in a dangerous position; and upon determination that the first subject is in the dangerous position, output a warning.

What is claimed is:

1. A method comprising:
receiving subject training data comprising a plurality of images of subjects in a plurality of positions on a person support apparatus;
labeling the plurality of images based on the positions of the subjects to generate labeled subject training data;
generating synthetic training data comprising computer generated images of artificial subjects in a plurality of positions on an artificial person support apparatus;
labeling the synthetic training data based on the positions of the artificial subjects to generate labeled synthetic training data; and
training a machine learning model based on the labeled subject training data and the labeled synthetic training data, using supervised learning techniques, to generate a trained model to predict a subject position based on an image of the subject.

2. The method of claim 1, wherein the machine learning model comprises one or more convolutional neural networks.

3. The method of claim 1, wherein the subject training data further comprises depth values associated with the subjects in the plurality of positions on the person support apparatus.

4. The method of claim 1, wherein the subject training data further comprises load sensor data associated with the subjects in the plurality of positions on the person support apparatus.

5. The method of claim 1, wherein the subject training data further comprises infrared images of the subjects in the plurality of positions on the person support apparatus.

6. The method of claim 1, wherein the subject training data includes video of the subjects, the method further comprising splitting the video of the subjects into the plurality of images of the subjects.

7. The method of claim 1, further comprising:
receiving a real-time image of a first subject on a first person support apparatus;
inputting the real-time image into the trained model; and
predicting a first position of the first subject based on an output of the trained model.

8. The method of claim 7, further comprising displaying information about the first position of the first subject.

9. The method of claim 7, further comprising causing a handheld device to display information about the first position of the first subject.

10. The method of claim 7, further comprising causing a remote computing device to display information about the first position of the first subject.

11. The method of claim 7, further comprising displaying a predetermined image associated with the first position of the first subject.

12. The method of claim 7, further comprising causing a handheld device to display a predetermined image associated with the first position of the first subject.

13. The method of claim 7, further comprising causing a remote computing device to display a predetermined image associated with the first position of the first subject.

14. The method of claim 7, further comprising:
determining an amount of time that the first subject has been in the first position; and
upon determination that the first subject has been in the first position for greater than a predetermined threshold amount of time, outputting a warning.

15. The method of claim 7, further comprising:
determining whether the first subject is in a dangerous position; and
upon determination that the first subject is in the dangerous position, outputting a warning.

16. A computing device comprising a processor configured to:
receive subject training data comprising a plurality of images of subjects in a plurality of positions on a person support apparatus;
label the plurality of images based on the positions of the subjects to generate labeled first subject data;
generate synthetic training data comprising computer generated images of artificial subjects in a plurality of positions on an artificial person support apparatus;
label the synthetic training data based on the positions of the artificial subjects to generate labeled synthetic training data; and
train a machine learning model based on the labeled subject training data and the labeled synthetic training data, using supervised learning techniques, to generate a trained model to predict a subject position based on an image of the subject.

17. The computing device of claim 16, wherein the machine learning model comprises one or more convolutional neural networks.

18. The computing device of claim 16, wherein the subject training data further comprises depth values associated with the subjects in the plurality of positions on the person support apparatus.

19. The computing device of claim 16, wherein the subject training data further comprises load sensor data associated with the subjects in the plurality of positions on the person support apparatus.

20. A system comprising:
one or more cameras configured to capture a plurality of images of subjects in a plurality of positions on a person support apparatus; and
a computing device communicatively coupled to the one or more cameras, the computing device comprising a processor configured to:
receive subject training data comprising a plurality of images of subjects in a plurality of positions on the person support apparatus;
label the plurality of images based on the positions of the subjects to generate labeled first subject data;
generate synthetic training data comprising computer generated images of artificial subjects in a plurality of positions on an artificial person support apparatus;
label the synthetic training data based on the positions of the artificial subjects to generate labeled synthetic training data; and
train a machine learning model based on the labeled subject training data and the labeled synthetic training data, using supervised learning techniques, to generate a trained model to predict a subject position based on an image of the subject.
